(19) United States
(12) Patent Application Publication
(10) Pub. No.: US 2016/0057627 A1
(43) Pub. Date: Feb. 25, 2016

(54) Method and Apparatus for Preventing Concealed, Unauthorized Wireless Data Access

(71) Applicant: WEWEWE GMBH, Göppingen (DE)

(72) Inventor: Axel Burgbacher, Goppingen (DE)

(73) Assignee: WeWeWe GmbH, Goppingen (DE)

(21) Appl. No.: 14/763,350

(22) PCT Filed: Jan. 24, 2014
(86) PCT No.: PCT/EP2014/051393

§ 371 Date: Oct. 27, 2015

(30) Foreign Application Priority Data
Jan. 25, 2013 (DE) 10 2013 001 241.4

(51) Int. Cl. H04W 12/08; H04B 5/00

(52) U.S. Cl. CPC H04W 12/08; H04B 5/0062; H04B 5/0012; H04B 5/0075

(57) ABSTRACT

In a method and an apparatus for preventing concealed, unauthorized wireless data access, a communication and identification element (1) which belongs to a transaction or identification system and wirelessly interchanges data has an electrical or mechanical interruption element (2) which prevents the wireless data connection (4) and is permanently in the interrupted position. The sensor elements (7) integrated in the communication and identification element can convert the acting force into an electrical, capacitive, resistive, inductive or piezoelectric signal, with the result that the interruption of the wireless data connection is cancelled during the time of the action of force.

### FIELD OF APPLICATION

The invention relates to a method and an apparatus for preventing concealed, unauthorized wireless data access, in particular in the case of cards for a card payment system, for example a credit, EC, cash or debit card, and cards for identifying persons, for example ID cards, patient cards, membership cards, or else access authorizations for buildings, rooms, machines, computers, devices, vehicles, conveying systems for persons and goods or systems of any type. Fields of application are wherever high identification and verification security is important and there is the risk of personal or confidential data being read by unauthorized persons.

The targeted allocation of access authorizations constitutes the basis for protecting intellectual, virtual and real property both in the real world and in the digital world. Whereas a simple key still provides good services for many elements in real life, ever more complex protection systems are used in the world of virtual and intellectual goods, which protection systems are in a constant race with criminal elements, for example computer hackers.

In this case, duties of care are often imposed on the individual citizen and can be performed by the latter only with difficulty in everyday use. The simplest and most obvious duty is still the fact that a citizen keeps his cash under lock and key or keeps an eye on his cash. However, cash is nowadays no longer the only means of payment: from the EC card, through credit cards, to email, there are a multiplicity of available instruments which are used during daily shopping in shopping malls as well as when visiting an online shop.

Short-distance radio systems (for example NFC, RFID) are currently being used more and more often here, which systems provide improved convenience as a result of the omission of PIN codes or signatures and simultaneously have a mechanically wear-free interface. As an example, it is possible to cite a wireless cash register system, past the so-called touch point of which a payment card only needs to be guided sufficiently closely or on the so-called touch point of which a payment card only needs to be placed in order to authorize the payment operation.

However, cards which are equipped with this system have a decisive security disadvantage: in addition to the desired payment operation on which a corresponding declaration of intent by the purchaser is based, there is unfortunately also the constant possibility of a third party gaining access to the data on the card without being noticed. This is usually achieved in the simplest manner by virtue of the unauthorized third party approaching the payment card only closely enough, for example in the queue for a cash register or by briefly placing his cell phone equipped with this technology onto the purse belonging to a customer waiting to pay, which purse is lying on the table.

The fact that the reading of intelligent cards by third parties is a massive security problem not only in transactions becomes clear when the various possible uses of such systems are borne in mind: health insurance card systems from which patient data can be read, ID cards, passports, driving licenses, membership cards, digital keys for the home or automobile. All of these cards can nowadays be read and examined; duplicates can likewise be easily created for misuse. The examples can be continued virtually without limitation.

The fact is that these systems are introduced onto the market on a large scale even though it is clear that the security has become substantially lower in comparison with conventional cards (with PIN, signature, etc.) since a third party does not even require any physical access to the card any more in order to misuse or forge it.

It is therefore useful to improve the current system by means of the present invention to the effect that such unauthorized access can be reliably prevented. The infrastructure of the payment systems remains unaffected thereby and cards having the new technology can be put into circulation during the conventional card replacement cycle and security can therefore be maximized with a small amount of effort. The advantages are therefore retained and the main disadvantage is eliminated. There is an urgent need for a new method and an apparatus for preventing undesirable or unnoticed reading of wirelessly available data from mobile or stationary data storage media and data processing systems by unauthorized third parties.

As a result of the increasing dissemination and acceptance of, for example, mobile electronic means of payment such as mobile telephones or cash and credit cards provided with radio communication, the risk of personal banking data getting into criminal hands virtually unnoticed rises incalculably. Current bank cards, for example, are de facto considerably less secure than conventional cards as a result of this new radio technology. A potential thief accesses the credit card kept in the purse virtually in passing without any physical contact and thus possibly gains access to the owner's account.

### Problem and Solution

The invention is based on the problem of providing a method mentioned at the outset and a corresponding apparatus which can be used to solve problems of the prior art, and, in particular, it is necessary to reliably prevent undesirable and unnoticed reading by third parties.

This problem is solved by means of a method having the features of claim 1 and an apparatus having the features of claim 9. Advantageous and preferred configurations of the invention are the subject matter of the further claims and are explained in more detail below. In this case, some of the features are mentioned only for the method or only for the apparatus. However, irrespective of this, they are intended to be able to independently apply both to the method and to the apparatus. The wording of the claims is incorporated in the description by express reference.

According to the invention, in the case of the method and apparatus for preventing concealed, unauthorized wireless data access, a communication and identification element which belongs to a transaction or identification system and wirelessly interchanges data has an electrical or mechanical interruption element, for example a switch or pushbutton or a sensor element, which prevents or interrupts the wireless data connection. The interruption element is permanently in the interrupted position. This interruption of the wireless data connection or the interrupted position is canceled, to be precise either permanently or only during the time of action, for example for 0.1 sec to 10 sec, by virtue of the action of a defined force or a capacitive, electrical, electromagnetic or magnetic field on the communication and identification element from the outside at one or more defined locations.

Suitably designed interruption elements or sensor elements which convert the acting force into an electrical, capacitive, resistive, inductive or piezoelectric signal may accordingly be integrated in the communication and identification element. The interruption of the wireless data connection can therefore be canceled during the time of the action of force.

The switching or sensor elements integrated in the element may be part of the sheath of the communication and identification element. The mechanical deformation thereof and a force absorption can also be used to generate signals or to initiate switching operations directly or by means of sensor elements.

An electrical, electronic, electromechanical, capacitive or magnetic pushbutton can be advantageously provided as an interruption element for canceling the interruption of the wireless data connection. This pushbutton can also provide an operator with haptic feedback. Pushbuttons having mechanical operation have the advantage that they cannot be disturbed by magnetic or electrical fields from the outside. Alternatively, it is possible to provide sensor elements for detecting a pressure, for example piezoelectric sensor elements.

The canceling of the interruption of the wireless data connection may end after a defined time even in the case of continuous action of force or action of a field on the sensor elements of the communication element. A time of reduced security can therefore be limited.

It is possible to provide further reference sensor elements for offset calibration. This increases operational reliability.

The communication element can be advantageously equipped with active or passive transponder elements for the purpose of generating and transmitting and receiving radio signals. The range thereof can be limited by the design of the hardware or software, with the result that influencing can be effected only from close range and therefore actually only by the operator himself. In any case, external influencing would be immediately noticed on account of the short range.

Provision may be made for the communication element to be inserted completely or sufficiently deeply, for the purpose of shielding radio signals, into a device which generates the specific pressure force required and is used to read wireless data signals. Two functions can therefore be performed in one step. Furthermore, such a payment operation using a card or apparatus according to the invention can be distinguished only slightly from a previous payment operation.

The communication element is advantageously in the form of a payment, transaction and/or identification card, that is to say has the form of a card. In a particularly advantageous manner, it has the size of conventional check cards with a similar thickness, under certain circumstances somewhat thicker, preferably 1 mm to 3 mm or 5 mm.

An above-mentioned payment, transaction and/or identification card may be provided in an at least partially enclosing manner, preferably in an enclosing manner on one side, both sides or completely, with a layer which shields electrical or electromagnetic fields. This increases the security against external influencing. The shielding layer may be designed to act as an antenna element during the time of action by virtue of mechanical or electrical action.

These and further features emerge not only from the claims but also from the description and the drawings, in which case the individual features can each be implemented alone or together in the form of subcombinations in one embodiment of the invention and in other fields and may constitute advantageous and inherently protectable embodiments for which protection is claimed here. The subdivision of the application into individual sections and intermediate headings does not restrict the generality of the statements made under said sections.

### BRIEF DESCRIPTION OF THE DRAWINGS

Exemplary embodiments of the invention are schematically illustrated in the drawings and are explained in more detail below. In the drawings:

FIGS. 1 to 5 show cards or so-called smart cards according to the invention with a pushbutton as an interruption element in different designs,

FIGS. 6 and 7 show possible handling modes of the cards,

FIGS. 8 and 9 show different functional states of the cards in the handling modes from FIGS. 6 and 7, and

FIG. 10 shows a reader having a card according to the invention therein.

### DETAILED DESCRIPTION OF THE EXEMPLARY EMBODIMENTS

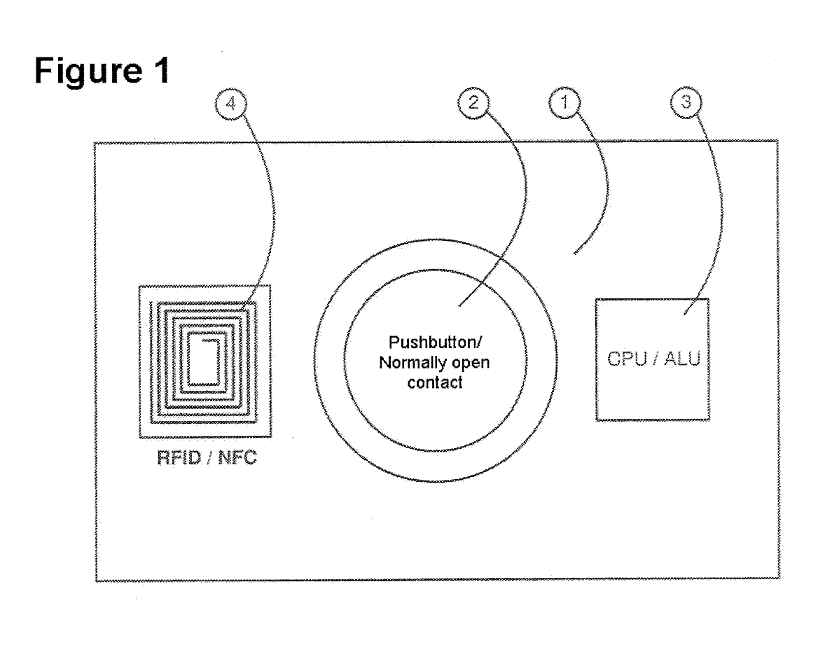

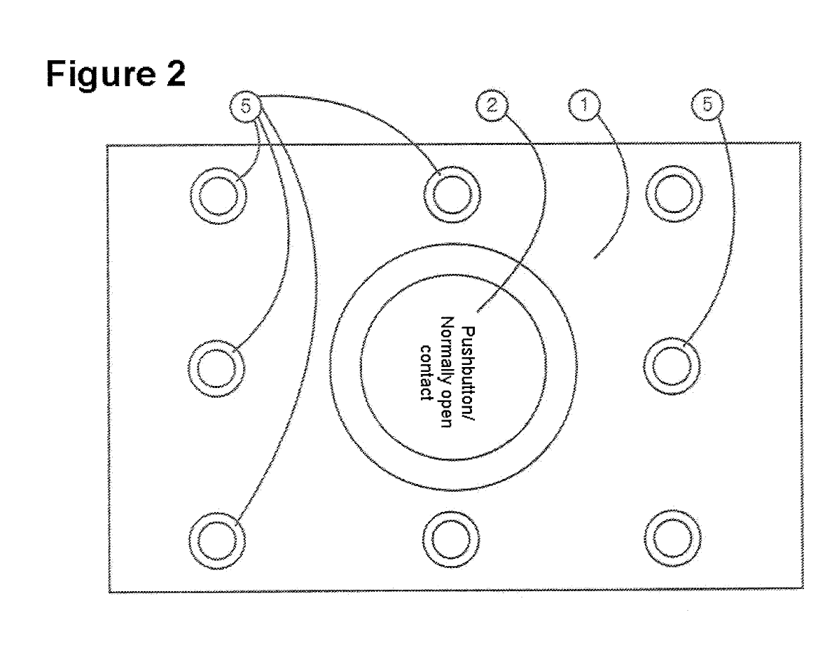

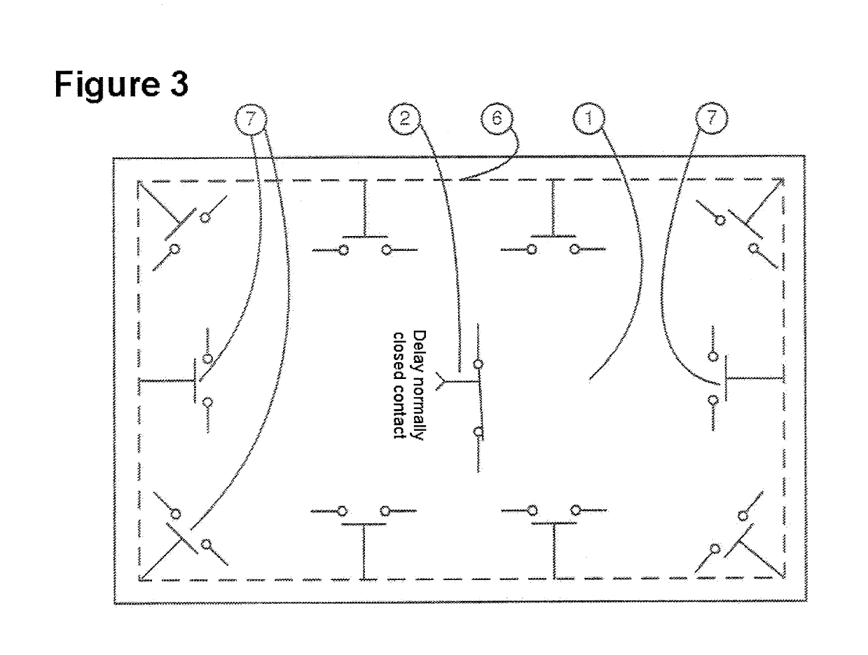

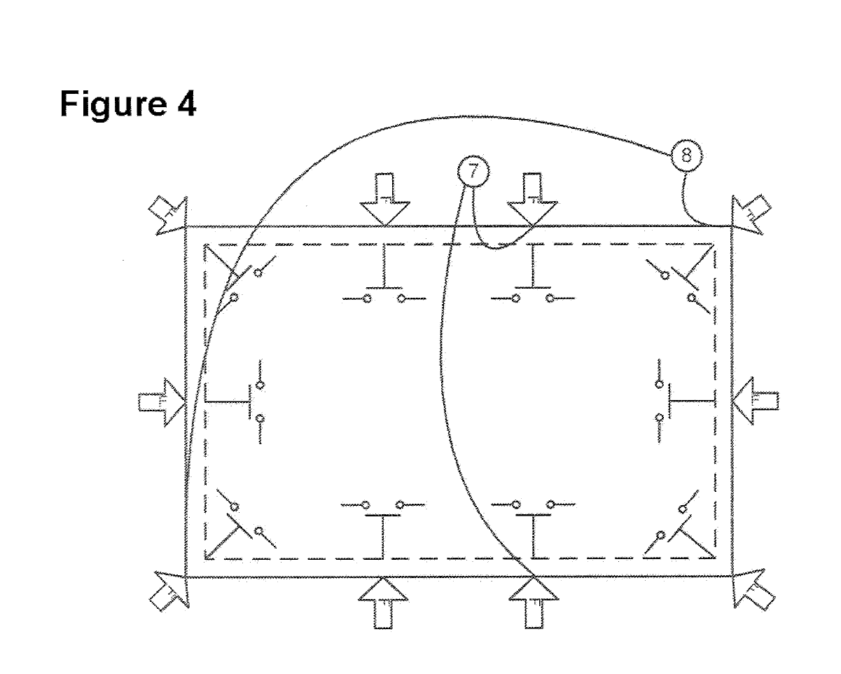

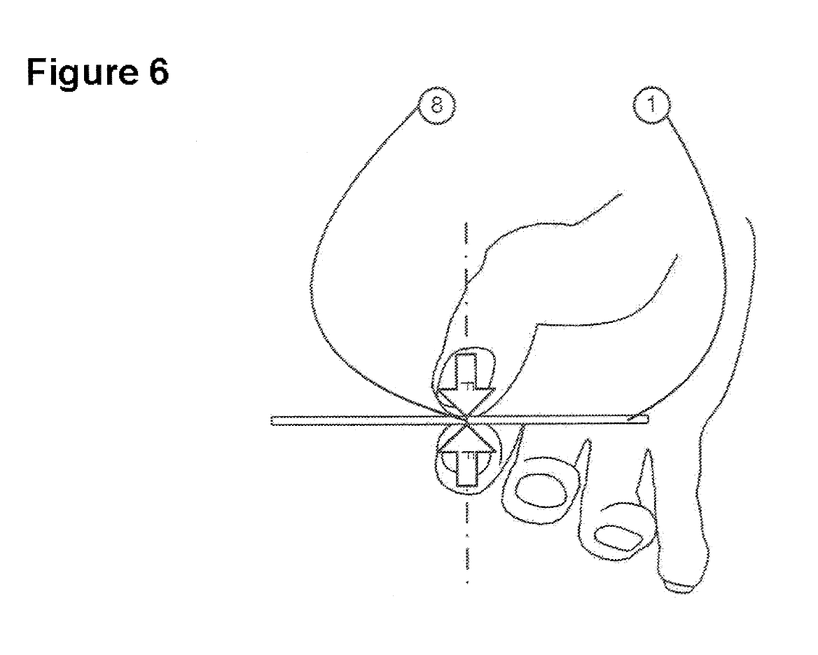

One or more electrical or mechanical switching or interruption elements 2, for example in the form of switches or pushbuttons or in the form of a pressure sensor element, are integrated in a card 1 belonging to a payment or identification system according to FIG. 1. This may be a so-called smart card. These include credit cards as well as EC or cash and debit cards, but also identification systems such as electronic keys or ID cards. In this case, this switching element 2 must not be able to be optically or haptically identified as such. An increased pressure, for example between the thumb and other fingers of a hand, with which such a card is held at a wireless payment terminal for the payment operation, suffices to initiate a switching or touch-operated function and thereby to enable the data transmission function by radio signal, see FIG. 6. In this case, an initiating force 8 should be applied in a punctiform manner; a two-dimensional force of any desired size does not result in the switching function according to the invention. This prevents the switching function from being able to be initiated in an undesired manner by merely carrying the credit card in the purse or in a trousers pocket. This can be effected by measuring the pressure of reference points, by means of a matrix having measurement points 5 according to FIG. 2 or by means of a reference tactile sensor.

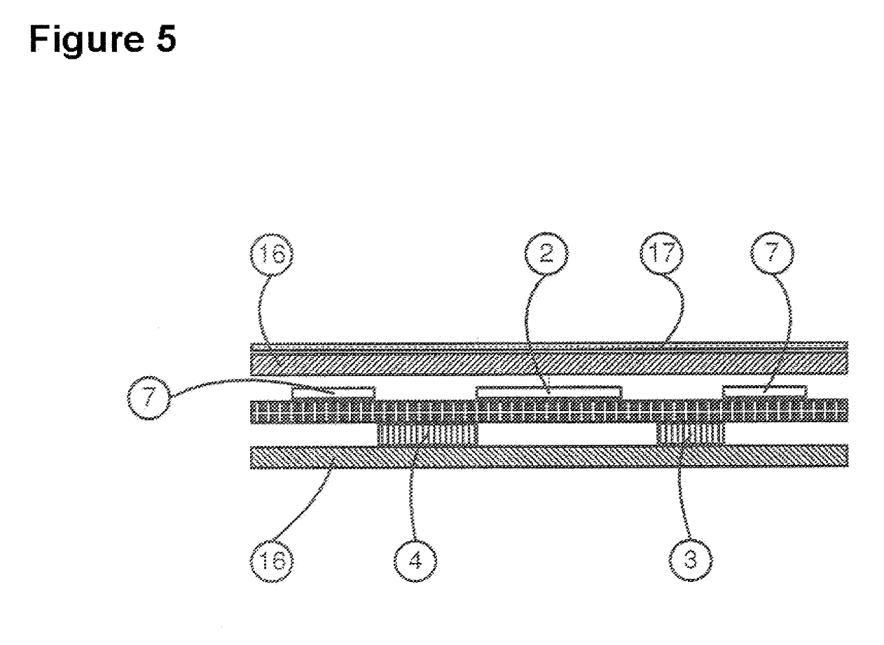

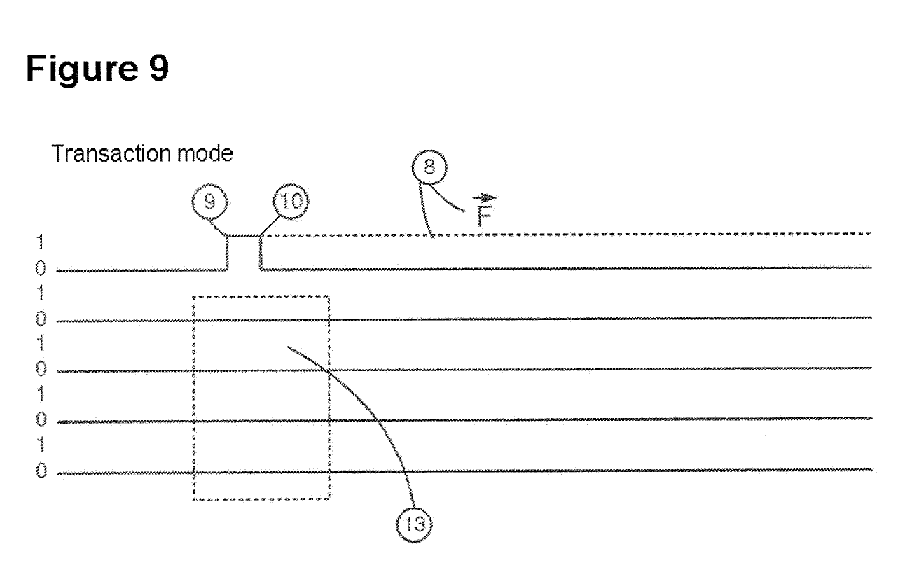

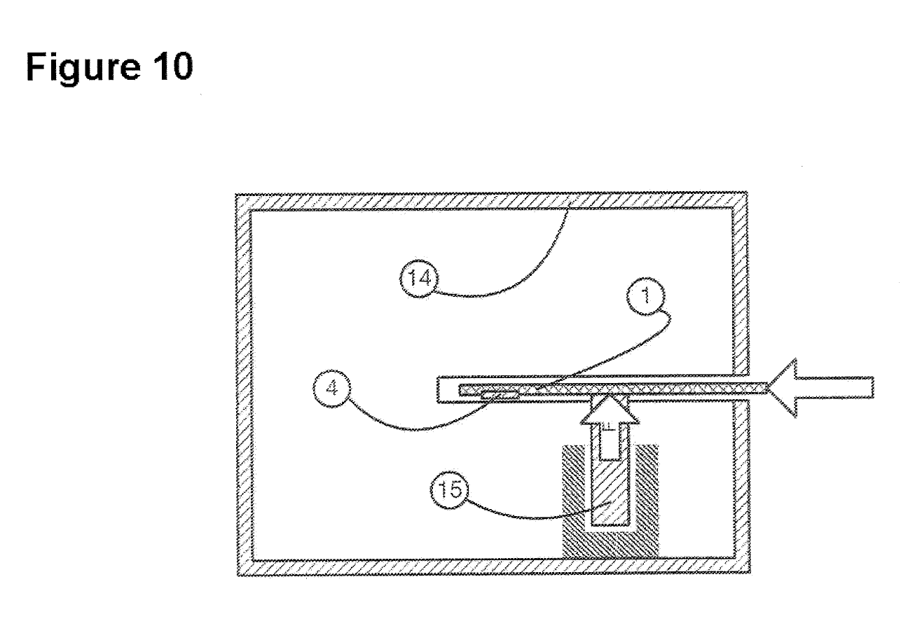

A money card 1 equipped with the features of the invention is therefore protected against being read by third parties since a radio connection for carrying out a payment operation is set up only for a short moment 9 to 10 according to FIG. 9. Furthermore, the card 1 is securely in the hand of the person paying at this moment according to FIGS. 5 and 6, where reading is rendered virtually impossible on account of the spatial distance from unauthorized readers.

The use of smart cards equipped according to the invention means that known skimming methods are no longer effective. Previously customary protective sheaths for shielding radio signals therefore become superfluous.

The switching point initiation can optionally also be combined with biometric sensor elements or methods, for example fingerprinting etc. However, this is not only rejected by many but in the meantime is also no longer considered to be absolutely secure.

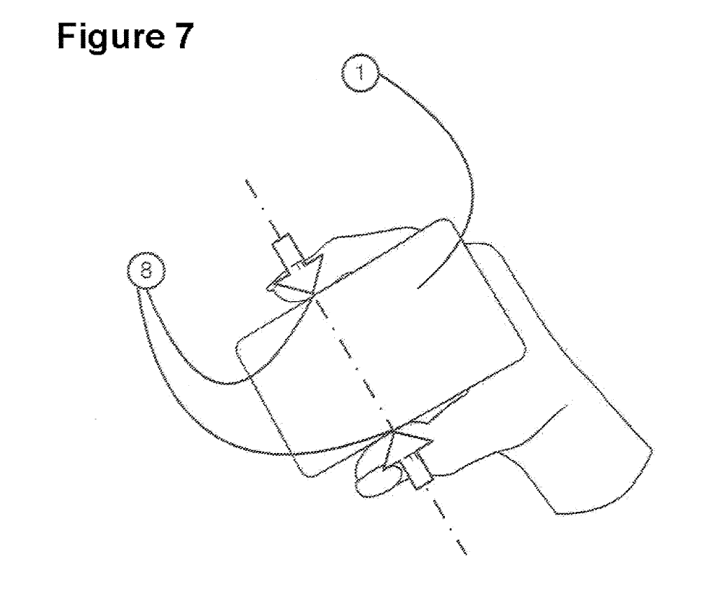

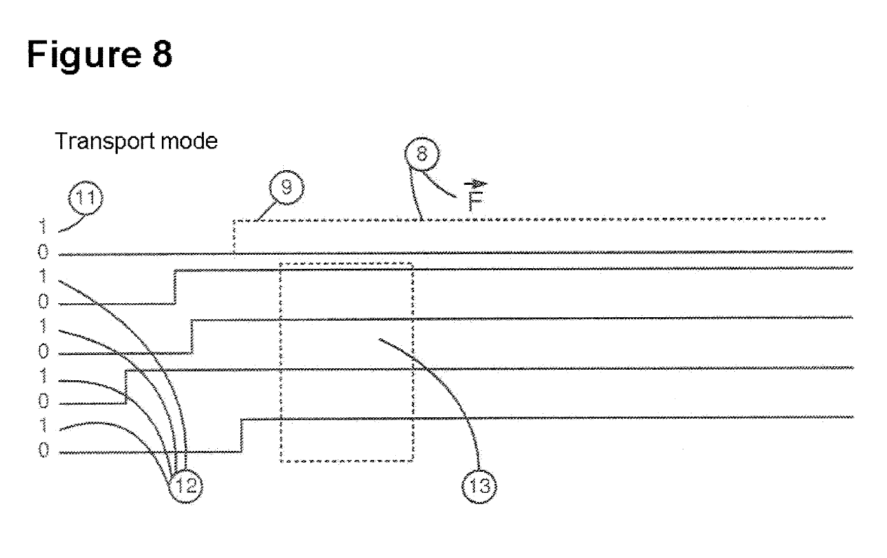

In the case of the present invention, the card may be in at least two different modes: in the transport mode according to FIG. 7 and in the transaction mode according to FIG. 6. The transaction mode is activated only for the short moment 9 to 10 of carrying out a transaction, which is advantageously between 0.5 seconds and 3 seconds, that is to say a payment, an identification or the opening of a lock, for example. After the transaction has been concluded, the card automatically changes to the transport mode in which it remains until the renewed changeover to the transaction mode. The decisive factor in this case is the deliberate and intentional activation of the transaction mode.

The card 1 equipped with an electrical or mechanical interruption element 2 or sensor element according to the invention can be carried by the user, moved, picked up and shown without the card emitting a radio signal typical of smart cards, for example via an RFID or NFC element 4, or reacting to a signal externally directed to the card since the connection to elements which process a radio signal is interrupted in a preset manner.

If the initiating force F 8 produced with the thumb is now exerted on the uppermost sheathing layer 16 of the card 1, which layer is advantageously printed with a surface 17 used for orientation, this results in the activation of the radio signal from a transmission apparatus 4 integrated in the card, which radio signal is continuously interrupted in the transport mode. The card is now in the transaction mode according to FIGS. 6 and 9 and can transmit its radio signal which extends only to a short distance, advantageously between 0 cm and 5 cm, as intended and can initiate the desired transaction or identification.

The reference sensor elements 5 illustrated in FIG. 2 are optionally queried at the same time as the actuation of the electrical or mechanical interruption element 2 and are used for the offset adjustment of the entire measurement matrix. In this case, the action of force F is processed, for example by means of electrical, capacitive, resistive, inductive or piezoelectric signals, in a signal processor, that is to say a CPU with an ALU unit 6. If the measured values from the reference sensor elements 5 are within a defined tolerance window 13, which advantageously comprises a period of 0 to 3 seconds, around the measured value 11 from the electrical or mechanical interruption element 2 or if the logical switching states largely correspond (definable by fuzzy logic, for example) in the case of simple switching elements, the card 1 does not change to the transaction mode but rather remains in the transport mode. This is because a two-dimensional action of force can then be assumed, as occurs during storage or transport in a purse or back pocket.

In this case, the number of corresponding switching states is dependent on the total number of installed switching elements and is advantageously more than 50% of the number of switching elements or is a geometrical switching pattern which is typical of the case of transportation, advantageously in the form of a triangle consisting of three switching elements arranged at right angles.

1. A method for preventing concealed, unauthorized wireless data access, wherein a communication and identification element which belongs to a transaction or identification system and wirelessly interchanges data has an electrical or mechanical interruption element which prevents or interrupts the wireless data connection,
the method comprising setting the electrical or mechanical interruption element permanently in the interrupted position, and
cancelling this interruption of the wireless data connection or the interrupted position either permanently or only during the time of action by virtue of the action of a defined force or a capacitive, electrical, electromagnetic or magnetic field on the communication and identification element from the outside at one or more defined locations.

2. The method as claimed in claim 1, wherein the sensor elements integrated in the communication and identification element convert the acting force into an electrical, capacitive, resistive, inductive or piezoelectric signal, with the result that the interruption of the wireless data connection is cancelled during the time of the action of force.

3. The method as claimed in claim 2, wherein the sensor or switching elements integrated in the element are part of the sheath of the communication and identification element and the mechanical deformation and force absorption thereof are used to generate signals or to initiate switching operations directly or by means of sensor elements.

4. The method as claimed in claim 1, comprising an electrical, electronic, electromechanical, capacitive or magnetic pushbutton as an interruption element for canceling the interruption of the wireless data connection.

5. The method as claimed in claim 1, wherein the canceling of the interruption of the wireless data connection ends after a defined time even in the case of continuous action of force or action of a field on the sensor elements of the communication element.

6. The method as claimed in one of the preceding claims, wherein further reference sensor elements for offset calibration are provided.

7. The method as claimed in claim 1, wherein the communication element is equipped with active or passive transponder elements for the purpose of generating and transmitting and receiving radio signals, the range of which can be limited by the design of the hardware or software.

8. The method as claimed in claim 1, wherein the communication element is inserted completely or sufficiently deeply, for the purpose of shielding radio signals, into a device which generates the specific pressure force and is used to read wireless data signals.

9. An apparatus for preventing concealed, unauthorized wireless data access, in particular for carrying out the method as claimed in claim 1, wherein a communication and identification element which belongs to a transaction or identification system and wirelessly interchanges data has an electrical or mechanical interruption element which prevents the wireless data connection and is permanently in the interrupted position, in which case the interruption element can be changed from the interrupted position to a closed position for enabling the wireless data connection by virtue of the action of a defined force or a capacitive, electrical, electromagnetic or magnetic field on the communication and identification element from the outside at one or more defined locations.

10. The apparatus as claimed in claim 9, wherein the interruption of the wireless data connection can be cancelled during the time of action by virtue of the action of a defined force on the communication and identification element from the outside at one or more defined locations.

11. The apparatus as claimed in claim 9, wherein the sensor elements integrated in the communication and identification element convert the acting force into an electrical, capacitive, resistive, inductive or piezoelectric signal in order to cancel the interruption of the wireless data connection during the time of the action of force.

12. The apparatus as claimed in claim 9, wherein the sensor or switching elements integrated in the element are part of the sheath of the communication and identification element and the mechanical deformation and force absorption thereof are used to generate signals or to initiate switching operations directly or by means of sensor elements.

13. The apparatus as claimed in claim 9, wherein an electrical, electronic, electromechanical, capacitive or magnetic pushbutton is provided as an interruption element for interrupting the wireless data connection.

14. The apparatus as claimed in claim 9, wherein the communication element is in the form of a payment, transaction and/or identification card.

15. The apparatus as claimed in claim 14, wherein the payment, transaction or identification card is provided in an at least partially enclosing manner, preferably in an enclosing manner on one side, both sides or completely, with a layer which shields electrical or electromagnetic fields, in which case, the screening layer is preferably designed to act as an antenna element during the time of action by virtue of mechanical or electrical action.

16. The apparatus as claimed in claim 9, wherein the canceling of the interruption of the wireless data connection ends after a defined time even in the case of continuous action of force or action of a field on the sensor elements of the communication element.

17. The apparatus as claimed in claim 9, wherein further reference sensor elements for offset calibration are provided.

18. The apparatus as claimed in claim 9, wherein the communication element is equipped with active or passive transponder elements for the purpose of generating and transmitting and receiving radio signals, the range of which can be limited by the design of the hardware or software.

19. The apparatus as claimed in claim 9, wherein the communication element can be inserted completely or sufficiently deeply, for the purpose of shielding radio signals, into a device which generates the specific pressure force and is used to read wireless data signals.
